(19) United States
(12) Patent Application Publication
(10) Pub. No.: US 2010/0004795 A1
(43) Pub. Date: Jan. 7, 2010

(54) PLASMA PROCESSING METHOD AND PLASMA PROCESSING APPARATUS

(75) Inventors: Takehisa IWAKOSHI, Tokyo (JP); Go Saito, Hikari-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Technologies Corporation

(21) Appl. No.: 12/199,838

(22) Filed: Aug. 28, 2008

(30) Foreign Application Priority Data
Jul. 3, 2008 (JP) 2008-174428

(51) Int. Cl. G05D 23/00; G06F 17/10

(52) U.S. Cl. 700/300; 703/2

(57) ABSTRACT

The invention provides a plasma processing apparatus capable of setting the temperature of the plasma processing chamber accurately to a specific state, and to perform highly accurate plasma processing while maintaining a constant plasma processing property. The plasma processing apparatus for subjecting a sample w to be processed to plasma processing within a plasma processing chamber 1 comprises a database 25 for correlating and storing the inner temperature of the plasma processing chamber 1 and the plasma generating condition, a model expression storage unit 26 for storing the correlating equation of the inner temperature of the plasma processing chamber 1 and the plasma generating condition from the database 25, and a computing machine 21 having an operation unit 24 for creating the correlation equation and the optimum plasma generating condition, further having a process monitor 31 for monitoring the condition of plasma processing, wherein the value output by the process monitor and the temperature of the plasma processing chamber are correlated and stored in the database 25, and the computing machine 21 computes a plasma processing condition capable of realizing a substantially constant plasma processing chamber temperature, based on which the plasma processing chamber performs plasma processing.

The present application is based on and claims priority of Japanese patent application No. 2008-174428 filed on Jul. 3, 2008, the entire contents of which are hereby incorporated by reference.

### BACKGROUND OF THE INVENTION

1. Field of the Invention

The present invention relates to plasma processing apparatuses, especially capable of realizing highly accurate plasma processing in the process of manufacturing semiconductor devices.

2. Description of the Related Art

Plasma processing is used for example to process or modify the surface of the object to be processed by enhancing the chemical reactivity by degrading processing gas via plasma. For example, in a semiconductor manufacturing line, plasma processing is used to deposit thin films on the surface of semiconductor wafers or to perform etching thereof to obtain the desired processing results.

Chemical reaction generally depends on the temperature of the processing chamber, and the above-mentioned plasma processing also depends on the temperature of the plasma processing chamber. Therefore, the fluctuation of temperature of the plasma processing chamber is directly reflected as the fluctuation of results of plasma processing. On the other hand, in manufacturing semiconductor devices, a processing accuracy in the order of a few nanometers has been demanded, along with the recent refinement and improved performance of the semiconductor devices. In order to realize such processing accuracy, an art is required to realize stable plasma processing by maintaining the temperature of the plasma processing chamber constant.

The prior art technique for overcoming the above-mentioned problem is proposed in Japanese patent application laid-open publication No. 2003-514390 (patent document 1), disclosing a method for maintaining a constant processing chamber temperature, and the temperature setting for enabling stable plasma processing. However, the disclosed art is not sufficient for maintaining a constant inner temperature of the plasma processing chamber. The reason for this is because there are areas in the interior of the processing chamber that cannot be provided with temperature control mechanisms, or are as that cannot be subjected to temperature control since the thermal conductance with respect to the temperature control mechanisms is not good. Those with ordinary skill in the art are familiar with the problem of such areas in the chamber being heated when plasma processing is started.

Japanese patent application laid-open publication No. 2006-210948 (patent document 2) discloses a method for controlling the temperature of the plasma processing chamber via plasma so as to overcome the above-mentioned prior art problem.

However, when the apparatus is used continuously, the temperature of the plasma processing chamber becomes high, and when an apparatus having been stopped for a while is reused, the temperature of the plasma processing chamber is low. The rapid reheating of the plasma processing chamber having a reduced temperature has the following drawbacks. In order to perform rapid heating, a plasma generating condition capable of applying a high energy to the inner walls of the plasma processing chamber via plasma must be set, but since the heating progresses rapidly, temperature control becomes difficult. According to experiments conducted by the present inventors, in an extreme case, a change as little as a few degrees of temperature of the plasma processing chamber may cause defects. However, the prior art does not describe the method for realizing such accurate temperature control. Of course, accurate temperature control can be realized by using a plasma generating condition that increases the temperature gradually, not rapidly. However, since the target object cannot be subjected to plasma processing during such temperature control, the production efficiency is deteriorated, so such art cannot be applied to mass production facilities. Thus, the plasma processing apparatus is required to realize both improved control accuracy and shorter control time.

### SUMMARY OF THE INVENTION

In view of the prior art problems mentioned above, the present invention aims at providing a plasma processing apparatus and plasma processing method capable of realizing a specific plasma processing chamber temperature accurately using plasma, to maintain a constant plasma processing property and to realize highly accurate plasma processing.

In order to solve the problems mentioned above, the present invention provides a plasma processing method in which the heating step for heating the plasma processing chamber using plasma is composed of two or more steps including a rapid heating step for cutting down heating time and a high accuracy control step for controlling the temperature highly accurately. Moreover, the present invention provides a plasma processing apparatus comprising a computing machine for computing the optimum plasma heating condition including a database associating the plasma generating condition and the inner temperature of the plasma processing chamber, a model expression storage unit for storing said relation substituted into a correlating equation, and an operation unit for creating the correlating equation and for computing the optimum plasma heating condition based on the correlating equation.

According to the present invention, it becomes possible to accurately set the temperature of the plasma processing chamber to a specific condition using plasma, and to maintain a constant plasma processing property. Therefore, it becomes possible to perform highly accurate plasma processing.

### BRIEF DESCRIPTION OF THE DRAWINGS

FIG. 1 is a schematic view illustrating the arrangement of a general plasma processing apparatus;

FIG. 2 is an example of the steps of a general plasma processing process;

FIG. 3 is an example of the temperature transition within the plasma processing chamber caused by repeating the plasma process;

FIG. 4 illustrates steps of the plasma process according to the present invention;

FIG. 5 is an example of the transition of temperature within the plasma processing chamber when processing is performed according to the plasma processing steps of the present invention;

FIG. 6 is a plasma processing apparatus having a temperature computing machine for realizing the present invention; and

FIG. 7 shows the steps for determining the most appropriate plasma processing chamber temperature, wherein FIG. 7A shows the processing steps for correlating the emission spectra of plasma to the temperatures of the plasma processing chamber, and FIG. 7B shows the processing steps for estimating the temperature of the plasma processing chamber at the end of the lot processing.

### DETAILED DESCRIPTION OF THE PREFERRED EMBODIMENTS

Now, the preferred embodiments of the present invention will be described with reference to the accompanying drawings. In the following embodiments, the components having equivalent functions as those illustrated in the first embodiment are denoted with the same reference numbers as the first embodiment, and the detailed descriptions thereof are omitted.

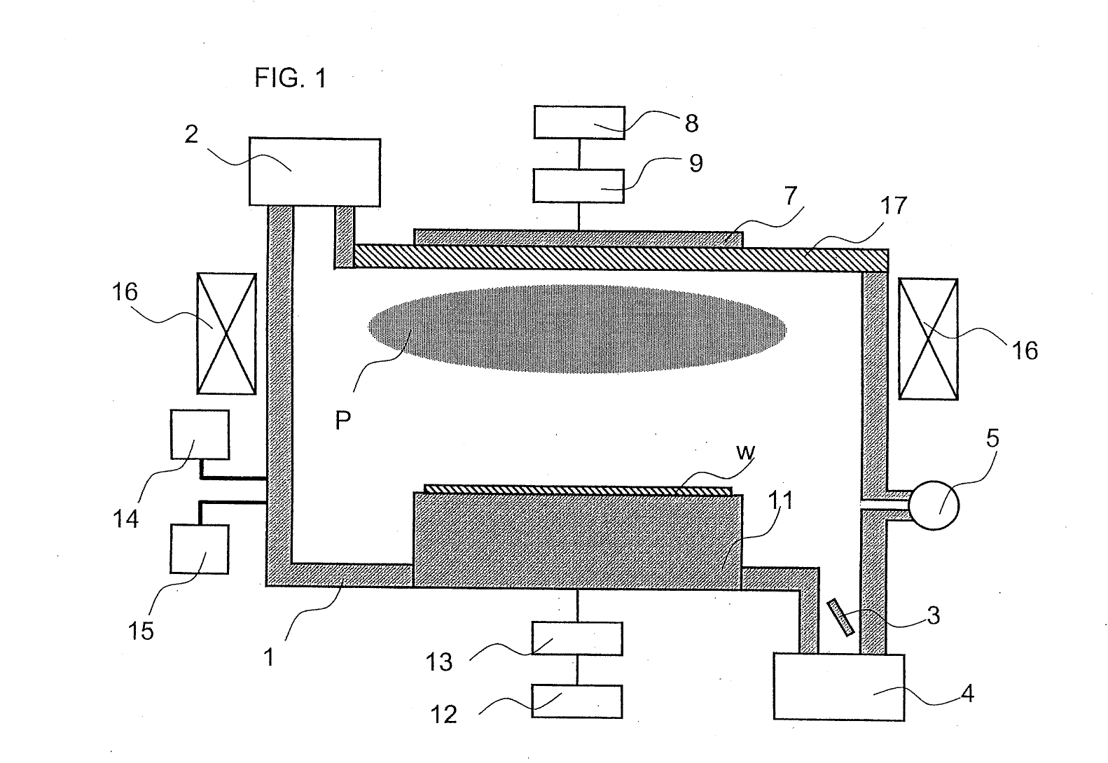

First, with reference to FIG. 1, the outline of the arrangement of a plasma processing apparatus to which the present invention is applied will be described. The plasma processing apparatus comprises a plasma processing chamber 1 for subjecting an object to be processed to plasma processing, a gas supply means 2 for supplying processing gas into the chamber, a valve 3, a gas evacuation means 4 and a pressure meter 5 for evacuating the processing gas and controlling the pressure within the plasma processing chamber 1, a stage 11 for supporting an object w to be processed, a plasma generating means (antenna) 7 for irradiating high frequency waves into the plasma processing chamber 1 to generate plasma P, a plasma generating high frequency power supply 8 for supplying power to the plasma generating means 7, and a plasma generating tuner (matching circuit) 9 for controlling the impedance. Further, the stage 11 is equipped with a bias high frequency power supply 12 for applying voltage to the stage, and a bias tuner (matching circuit) 13 for controlling the impedance. Moreover, a temperature control mechanism 14 and a temperature measuring mechanism 15 are provided to control the temperature of the plasma processing chamber 1. In addition, according to the type of the plasma processing apparatus, there are one or more coils 16 provided to assist the generation of plasma P or to control the distribution of plasma P via magnetic field. Sometimes, the plasma generating means 7 also functions as the coil 16. In addition, a top panel 17 of the plasma processing chamber 1 may not be formed of the same metal material as the processing chamber 1 but be formed of a dielectric such as quartz.

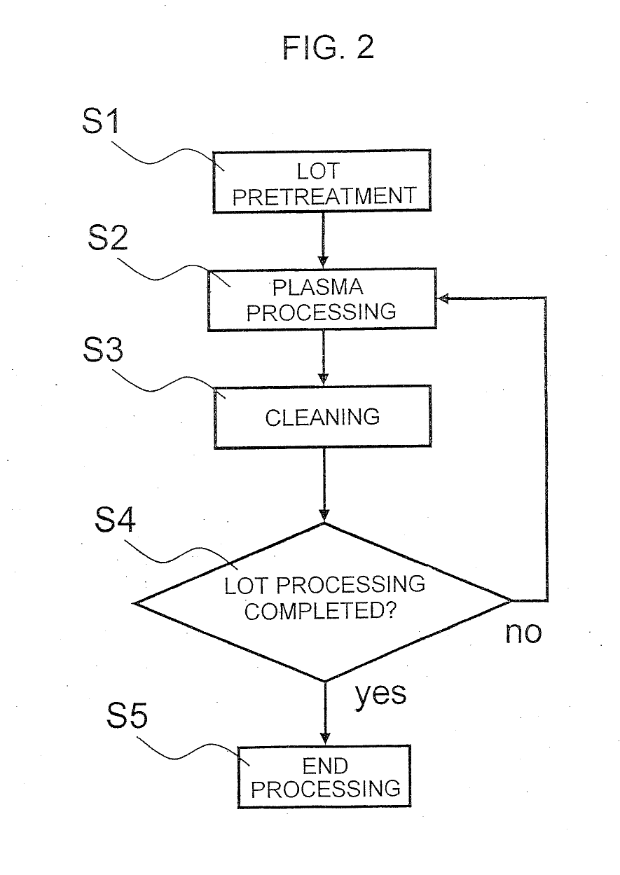

Prior to describing the present invention in detail, typical processing steps for subjecting a single lot of objects w to be processed using the aforementioned plasma processing apparatus will be described with reference to FIG. 2.

At first, a lot pretreatment S1 is performed without placing an object w to be processed on the stage 11. The lot pretreatment S1 is performed with the aim to raise the temperature of the processing chamber 1 using plasma, for example. Then, the target object w to be processed is placed on the stage 11 to perform plasma processing S2. When the process is completed, the object w to be processed is taken out of the processing chamber 1 and a cleaning S3 is performed. The object of cleaning S3 is to remove the residuals generated during the plasma processing S2, which is achieved by performing a plasma pretreatment without placing the target object w to be processed on the stage 11. When the cleaning S3 is completed and the procedure moves onto branch S4, if the processing of all the objects w of the lot is not completed, the steps from plasma processing S2 to branch S4 are performed repeatedly. In branch S4, if the processing of all the objects of the lot is completed, the procedure moves onto a process termination step S5. In the process termination step S5, no process may be performed, or a similar process as the cleaning S3 may be performed, or plasma may be continuously generated using rare gas or the like to prepare for the processing of the following lot.

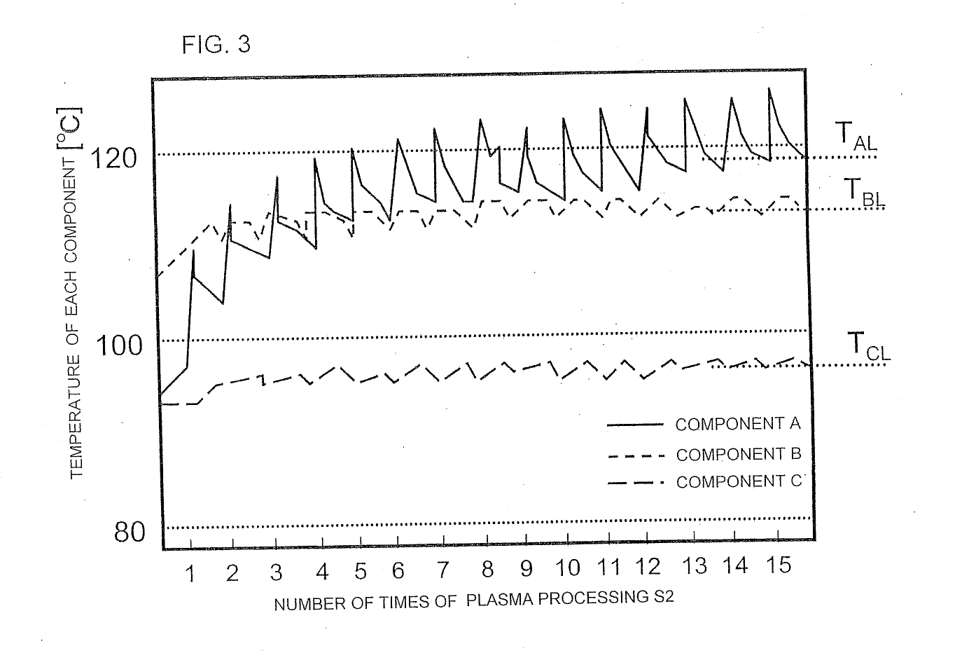

As described, upon processing the lot, the lot pretreatment S1, the plasma processing S2 of the object to be processed and the cleaning S3 are performed alternately, during which time plasma is generated and extinguished repeatedly. When plasma is generated, the plasma processing chamber is heated and the temperature thereof is high, but when the plasma is extinguished, the temperature is low, and thus, the temperature in the plasma processing chamber transits while repeating rise and fall as illustrated in FIG. 3. In FIG. 3, the horizontal axis represents the number of times of plasma processing S2 in FIG. 2, each taking approximately 5 minutes, depending on the type of the object to be processed.

The drawing illustrates the state in which the temperature rises and falls and reaches a substantially constant temperature T_{AL}, T_{BL} and T_{CL} by the repeated processes. This temperature is denoted as T_{nL}, wherein if T_{nL} is constantly realized via the plasma processing S2 in the steps of FIG. 2, the plasma processing can be reproduced highly accurately.

In order to realize the above-mentioned T_{nL}, a heat conduction equation (1) is considered.

[Expression 1 ]

cₙVₙdTₙ(t)/dt=Qₙ(t)Cₙₒ(tₙ(t)−Tₙₒ) (1)

In the left-hand side of equation (1), cₙ represents the specific heat of a certain component n in the reactor, Vₙ represents the volume, and the product of these values and temperature variation dTₙ(t)/dt per unit time of temperature Tₙ(t) is associated with the heat quantity received per unit time. In the right-hand side of the equation, T_{nO} is the temperature of other components functioning as a heat bath with respect to component n, C_{nO} is the thermal conductance between the component n and other components functioning as a heat bath, and Qₙ is the heat quantity flowing into the component n from heat sources such as plasma. In other words, it represents the heat quantity that component n receives per unit time from the plasma and circumference temperature distribution.

If the heat quantity Qₙ flowing to the component and the temperatures T_{nO} of other components functioning as the heat bath to the component are constant with respect to time, the solution of this equation (1) is as shown in equation (2).

[Expression 2 ]

Tₙ(t)=Tₙ(∞)−(Tₙ(∞)−Tₙ(0))exp(−t/τₙ) (2)

Here, Tₙ(0) is the temperature immediately prior to starting heating by plasma, Tₙ(∞) is a saturation point temperature reached when the heating via plasma is continued sufficiently (when t is so great that it can be considered as ∞), and τₙ is a time constant corresponding to the temperature transition. As can be seen from equation 2, the temperature Tₙ(t) of component n changes in an exponential manner, and reaches a constant temperature Tₙ(∞) at a speed of time constant τₙ.

The time constant τₙ representing the speed of saturation and the saturation point temperature Tₙ(∞) are shown in expressions (3) and (4).

[Expression 3 ]

τₙ=cₙVₙ/C_{nO} (3)

Tₙ(∞)=T_{nO}+Qₙ/Cₙₒ (4)

By focusing on expression (4), it can be recognized that the saturation point temperature Tₙ(∞) does not depend on the temperature Tₙ(0) of the plasma processing chamber immediately before heating, but can be controlled by the level of Qₙ, that is, the level of the heat quantity flowing in from the plasma or the like. In other words, by appropriately controlling the plasma generating condition, Tₙ(∞)=T_{nL} is expected to be achieved. Therefore, by quantitatively correlating relationship of Tₙ(∞) and plasma generating condition, the Tₙ(∞) under arbitrary plasma generating conditions can be estimated.

However, continuing the lot pretreatment process S1 until the temperature reaches a saturation point temperature Tₙ(∞) means time proportional to τₙ is required. According to experiments performed by the present inventors, the time required for Tₙ(t) to reach Tₙ(∞) takes approximately 15 to 40 minutes, depending on the location and variety of the component. During this time, the target object to be process cannot be processed. Therefore, in semiconductor device production lines, the cut down of heating time is desired. Therefore, by focusing on equation (1), in a short time, the temperature rise quantity dTₙ(t)/dt is proportional to Qₙ, and therefore, the temperature Tₙ(t) will increase rapidly as Qₙ increases. In other words, if a plasma generating condition with a large Qₙ is used, the plasma processing chamber can be heated rapidly. However, if Qₙ is too large, Tₙ(∞) will be greater than T_{nL}, and the target highly accurate temperature control cannot be realized.

Therefore, the present invention considers dividing the lot pretreatment S1 into two steps, wherein the first step is performed under a plasma generating condition in which the Qₙ is greatest, that is, a plasma generating condition in which a great thermal energy is applied to the plasma processing chamber, and the second step is performed under a plasma generation condition in which the Qₙ realizes Tₙ(∞)=T_{nL}, that is, a plasma generating condition in which the temperature of the plasma processing chamber reaches a desired temperature.

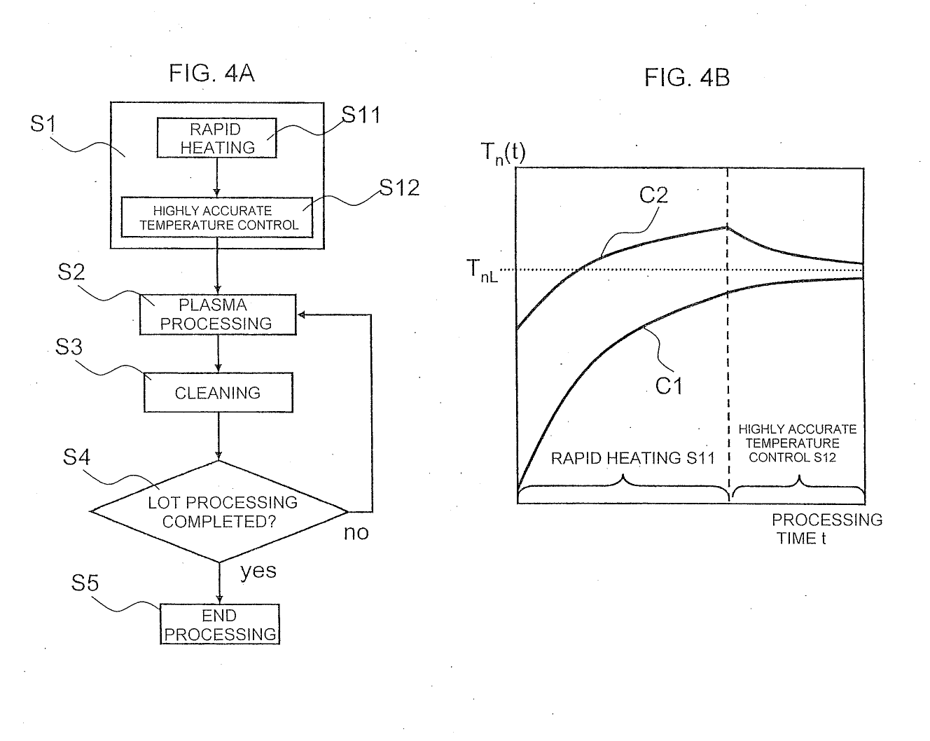

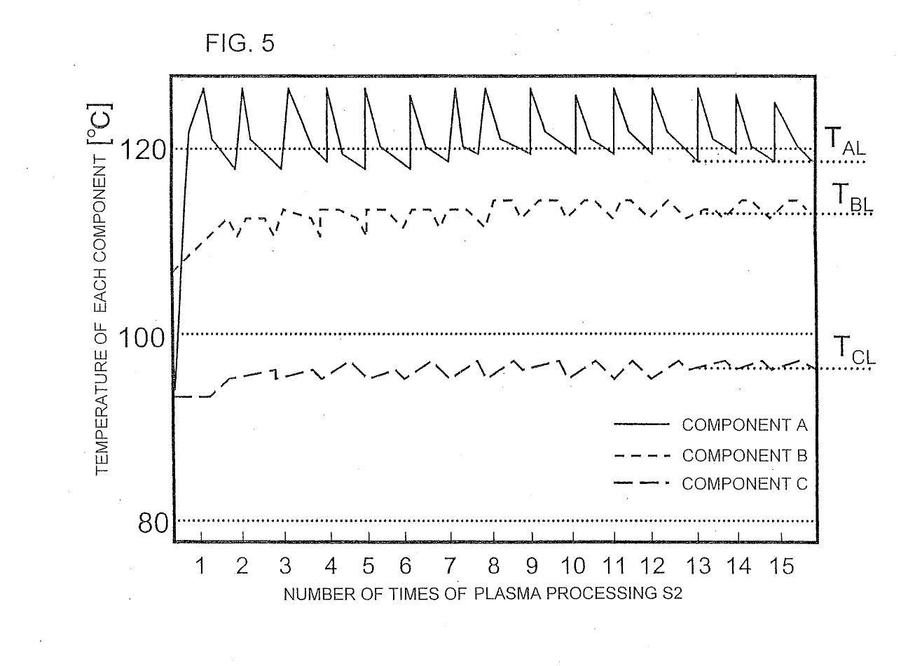

The above-mentioned steps are illustrated, for example, in FIG. 4A. It differs from the processing steps of FIG. 2 in that the lot pretreatment S1 is divided into two parts, a rapid heating step S11 and a high accuracy temperature control step S12. The transition of temperature of the plasma processing chamber shows a result illustrated in FIG. 4B by conducting experiments using these steps. That is, as shown by the curved line C1, when the initial temperature of the plasma processing chamber is low, the rapid heating step S11 enables the temperature Tₙ(t) to rise rapidly, and then via the high accuracy temperature control step S12, Tₙ(t) approximates the target temperature T_{nL}. On the other hand, as shown by the curved line C2, when the initial temperature of the plasma processing chamber is high, if Tₙ(t) becomes higher than the target temperature T_{nL} by the rapid heating step S11, the temperature is naturally lowered to correspond to T_{nL} during the high accuracy temperature control step S12. Further, when the lot is treated using the heating method according to the present invention, the change in temperature of the plasma processing chamber results in what is illustrated in FIG. 5. That is, since the temperature approximates T_{nL} when the lot pretreatment S1 is completed, the rise and fall of temperature thereafter repeats the same cycle. Thus, the plasma processing S2 can be performed under the same temperature, according to which the plasma processing can be reproduced highly accurately.

According to the present experiment, the lot pretreatment S1 is divided into two steps, but in general, the pretreatment can be divided into more than two steps, or the conditions used in step S11 of the procedure illustrated in FIG. 4 can be gradually varied to the condition used in step S12.

By dividing the lot pretreatment S1 into two steps according to the present invention, the temperature of the plasma processing chamber can be maintained constantly.

Further, in the description of the first embodiment of the present invention, a method was described for highly accurately controlling the plasma processing apparatus by selecting appropriate plasma generating conditions, but it lacked to describe clearly how the appropriate plasma generating conditions are selected. Temperature measuring devices should be attached to various points on the interior of the plasma processing chamber to measure the achieved temperature Tₙ(∞) by varying the plasma generating conditions, but the temperature measuring devices cannot be attached to product line apparatuses in order to prevent contamination and particles.

### Embodiment 2

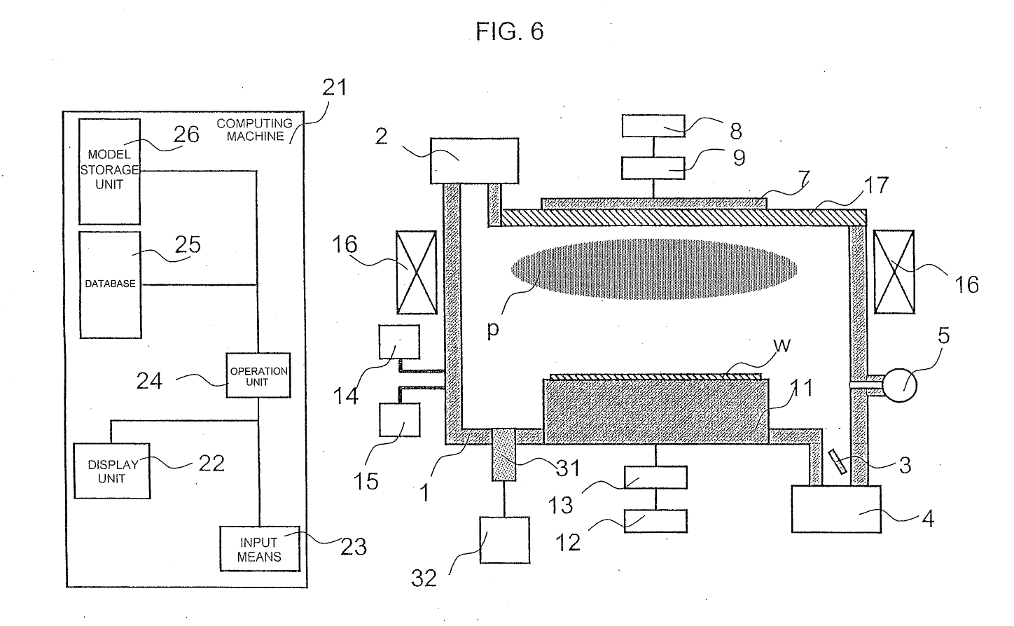

Therefore, with reference to FIG. 6, the second embodiment of the present invention will be described, in which a temperature computing machine is attached to a general plasma processing apparatus described in the first embodiment, wherein the optimum plasma generating condition is computed through the computing machine. FIG. 6 illustrates a plasma etching apparatus illustrated in FIG. 1 further equipped with a computing machine 21 having an operation unit 24, a display unit 22, a data input means 24, a database 25 and a model storage unit 26. The apparatus also includes a process monitor 31 and a process data logger 32, but the detailed methods for using the same are described later.

The method for using the computing machine 21 will now be described. At first, prior to shipping the plasma processing apparatus, temperature measuring devices are attached to each points on the interior of the plasma processing chamber 1, on the top panel 17, and on the upper and side surfaces of the stage 11. Thermocouples can be used for example as the temperature measuring devices, but since the thermocouples are affected by the electromagnetic waves for generating plasma P, it is more preferable to use fluorescent thermometers or the like that are not easily affected by the electromagnetic waves. Thus, the inner temperature of the plasma processing chamber 1 can be measured. Thereafter, plasma P is generated for a sufficiently long time via a variety of plasma generating conditions to obtain the achieving temperatures Tₙ(∞) of respective components. The Tₙ(∞) and a parameter set {Pₖ} of the plasma generating condition are entered to the database 25 via the data input means 24. The data input means 24 can be a device through which the operator can enter data manually, such as a keyboard, a mouse, a touch-pen or the like, but more preferably, it should be a media drive for reading in electromagnetic information such as a floppy (registered trademark) disk drive, andmostpreferably, a network interface for automatically reading in the measured Tₙ(∞) and parameter set {Pₖ}.

After storing sufficient data into the database 25, the operation unit 24 of the computing machine 21 performs computation so as to associate Tₙ(∞) and {Pₖ} to thereby obtain function Tₙ(∞)=f({Pₖ}). A well-known method should be used to crate function f ({Pₖ}), such as assuming a polynomial of Tₙ(∞) having {Pₖ} as variable, and performing regression analysis or principal component regression analysis to obtain the respective proportionality coefficients. For example, the following describes a method for creating a function f ({Pₖ}) using multiple regression analysis.

First, it is assumed that plasma generating conditions {Pₖ}₁, {Pₖ}₂, {Pₖ}₃, . . . {Pₖ}ₓ are retried by x number of experiments. At this time, it is assumed that the achieved temperature is Tₙ₁(∞), Tₙ₂(∞), Tₙ₃(∞), . . . Tₙₓ(∞). In order to connect the relationship between the plasma generating condition and the temperature, a linear first-order approximation as shown in the following expression (5) is assumed as function f ({Pₖ}).

[Expression 4 ]

Tₙ(∞)=Tₙ⁽⁰⁾+Σₖ(∂Tₙ(∞)/∂Pₖ)Pₖ (5)

The approximation assumes that temperature Tₙ(∞) is proportional to the various plasma generating parameters Pₖ, the proportional coefficient thereof is (∂Tₙ(∞)/∂Pₖ), and the intercept is Tₙ⁽⁰⁾. The values of intercept Tₙ⁽⁰⁾ and the proportional coefficient (∂Tₙ(∞)/∂Pₖ) are determined via a least-square method or the like so that the model expression of expression (5) corresponds to the experimental data obtained through x times of experiments. Thus, it becomes possible to estimate the value of saturation point temperature Tₙ(∞) according to arbitrary plasma generating conditions {Pₖ}.

Expression (2) solves the equation (1) by assuming that each of the components n contact the heat bath. However, if the thermal conductance of the components is high, the components may mutually be correlated. In such case, a model equation should be created as shown in equation (6) having a correlation with temperatures of other components. In this case, coefficient (∂Tₙ(∞)/∂Tₘ(∞)) can be obtained through fitting with the experimental data, similar to the case of (∂Tₙ(∞)/∂Pₖ).

$$\begin{matrix}[ Expression 5 ] & \\ {T}_{n} ( ∞ ) = {T}_{n}^{( 0 )} + {Σ}_{k} ( \frac{\partial {T}_{n} ( ∞ )}{\partial {P}_{k}} ) {P}_{k} + {Σ}_{m} ( \frac{\partial {T}_{n} ( ∞ )}{\partial {T}_{m} ( ∞ )} ) {T}_{m} ( ∞ ) & ( 6 )\end{matrix}$$

In expression (6), a factor Σₘ(∂Tₙ(∞)/∂Tₘ(∞))Tₘ(∞) is added to expression (5). This expression assumes that the temperature Tₙ(∞) of component n depends on the temperature Tₘ(∞) of another component m due to thermal conduction or the like, and the proportional coefficient is represented as (∂Tₙ(∞)/∂Tₘ(∞)).

One example of a method for determining the model expression for roughly estimating the saturation point temperature Tₙ(∞) has been described as above. However, some parameter sets {Pₖ} of plasma generating condition exist in which the temperature Tₙ(∞) is not linear. Examples of such parameters are the pressure of the plasma processing chamber and the current applied to the coil 16 according to studies performed by the inventors of the present invention. Such parameters can be subjected to a polynomial fitting including higher-order terms such as second order term and third order term, instead of the linear first-order approximation as in expression (5), in order to improve the accuracy of the model expression.

In order to perform such computation, the operation unit 24 can either be a central processing unit used in a common personal computer or an integrated circuit specialized for such computation. After creating the function Tₙ(∞)=f({Pₖ}), the function is stored in the model storage unit 26.

After completing this operation sequence, the temperature measuring devices attached to the interior of the plasma processing chamber 1 are removed, and the plasma processing chamber 1 is cleaned before being shipped.

There is no temperature measuring device attached to the shipped plasma processing apparatus, but it is possible to compute using the function Tₙ(∞)=f({Pₖ}) stored in the model storage unit 26 whether what Tₙ(∞) is obtained by selecting a specific plasma generation condition. That is, in the rapid heating step S11 of FIG. 4, the plasma generating condition {Pₖ} in which Tₙ(∞) becomes greatest is adopted, while in the high accuracy temperature control step S12, the plasma generating condition {Pₖ} in which Tₙ(∞) approximates T_{nL} is adopted. Thereby, it becomes clear what plasma generating condition should be adopted to realize an optimum Tₙ(∞), and the determination of plasma generating condition in a mass production line can be made effective.

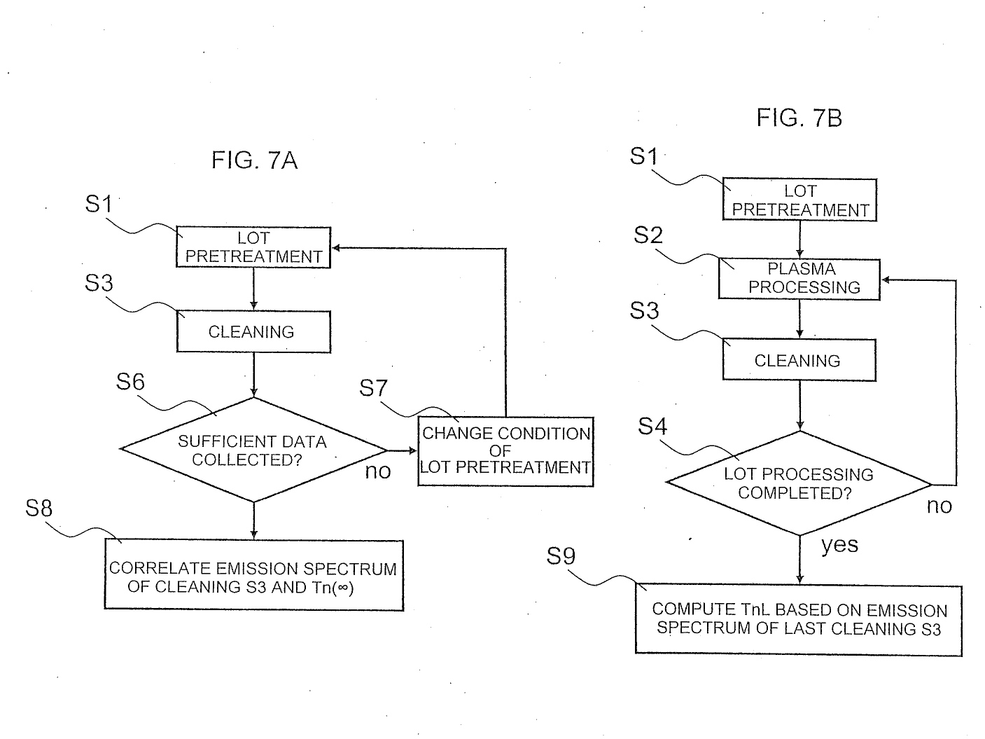

It is described in the above description that in the high accuracy temperature control step S12, temperature control can be performed highly accurately by determining the plasma generating condition {Pₖ} So that Tₙ(∞) approximates T_{nL}, but since T_{nL} is determined by what kind of condition is used to process the object to be processed, the value depends on the type of the object to be processed. However, since no temperature measuring devices are attached to the plasma processing apparatus shipped to the production line, there are no means for measuring T_{nL}. One example of steps for roughly estimating T_{nL} is illustrated in FIG. 7.

At first, the steps of FIG. 7A are performed. A lot pretreatment S1 is started under a certain plasma generating condition {Pₖ}, and a temperature Tₙ(∞) of the plasma processing chamber is achieved. Next, cleaning S3 is performed, the process status at that time being monitored via a process monitor 31 illustrated in FIG. 6, and the process status is output via a process data logger 32. The process status having been output is stored in a database 25 via a data input means 24, a line or a media drive not shown. The process status monitored by the process monitor 31 can be, for example, an emission spectrum of plasma used during cleaning S3. In this case, the process monitor 31 is made of quartz, a spectrometer or the like is used as the process data logger 32, and the former is connected to the latter via an optical fiber.

In branch S6, if sufficient data is not stored in the database 25, the plasma generating condition to achieve a different Tₙ(∞) is set in step S7, and the lot pretreatment S1 is performed again.

According to these steps, the Tₙ(∞) and the data such as the plasma emission spectrum are stored in the database 25 as a set, and when sufficient amount of data is obtained, the procedure proceeds to step S8. In step S8, Tₙ(∞) and the plasma emission spectrum are correlated via a generally well-known method such as a principal component regression analysis, a multiple regression analysis or a nonlinear regression analysis. Thereafter, the temperature Tₙ(t) during the time of measurement of plasma emission spectrum can be computed by simply measuring the plasma emission spectrum.

A method utilizing a principal component regression analysis as an example of correlation will now be described. At first, in the x times of experiments, it is assumed that via the lot pretreatment S1, the temperature of component n within the plasma processing chamber reaches Tₙ₁=Tₙ₁(∞), Tₙ₂=Tₙ₂(∞), Tₙ₃=Tₙ₃(∞), . . . , Tₙₓ=Tₙₓ(∞). In other words, such plasma generating conditions are used to achieve Tₙ₁(∞), Tₙ₂(∞), Tₙ₃(∞), . . . Tₙₓ(∞). Immediately after the lot pretreatment S1, the emission spectrum of plasma during cleaning S3 is observed by a spectrometer (plasma data logger) 32 via a quartz window (plasma monitor) 31. Preferably according to the present invention, the observed emission spectrum of plasma is directly output from the spectrometer 32 to the database 25, which is simultaneously correlated with the component temperature of the plasma processing chamber and stored.

The plasma emission spectrum observed at this time is referred to as I₁ (λₘ), I₂ (λₘ), I₃ (λₘ), . . . , Iₓ (λₘ) What is meant by I_{y} (λₘ) is that the m-th pixel of the spectrometer observing the emission spectrum corresponds to wavelength λₘ, and the plasma emission intensity at the y-th experiment in that wavelength is I_{y} (λₘ).

When a dataset of temperature T_{ny}(∞) and I_{y}(λₘ) are obtained as mentioned above, expressions (7) and (8) are used at first to compute the covariance matrix element S_{pq} of I_{y} (λₘ) by the operation unit 24.

[Expression 6 ]

S_{pq}=(x−1)⁻¹Σ_{y·z}(I_{y}(λₚ)−I_{A}(λₚ))(I_{z}(λ_{q})−I_{A}(λ_{q})) (7)

I_{A}(λₚ)=(x)⁻¹Σ_{y}I_{y}(λₚ) (8)

Expression (8) is a calculating formula to obtain an average emission spectrum I_{A} (λₚ), and expression (7) is a calculation method generally known for calculating covariance.

Next, the operation unit 24 computes an eigenvector and an eigenvalue based on S_{pq}. Methods for computing the eigenvector and the eigenvalue are well known, which for example compute a vector Lₓ (λₚ) and Λₓ that satisfy expression (9). In the following expression (9), the value of W is set in the order of W=1, 2, 3, . . . starting from where the |Λ_{W}| is greatest.

[Expression 7 ]

ΣₚS_{pq}L_{W}(λₚ)=Λ_{W}L_{W}(λ_{q}) (9)

Thus, a principal component score Z_{Wy} is computed based on the eigenvectors L_{w} (λₚ) and I_{y} (λₚ) defined by expression (3). The principal component score Z_{Wy} satisfies the relationship of expression (10) with L_{w} (λₚ) and I_{y} (λₚ).

[Expression 8 ]

Z_{Wy}=Σₚ(I_{y}(λₚ)−I_{A}(λₚ))L_{W}(λₚ) (10)

The relationship between a principal component score Z_{Wy} and a temperature T_{ny} (∞) of component n computed by the operation unit 24 is assumed as the following expression (11).

[Expression 9 ]

T_{ny}=A_{O}+Σ_{W}A_{W}Z_{Wy} (11)

The A_{O} and A_{W} in expression (11) are fitting parameters, and the operation unit 24 can determine the same via a least squares method or the like so that the set {Z_{Wy}} of principal component scores obtained via expression (10) and the temperature {T_{ny} (∞)} of component n correspond. At this time, it is preferable to perform a t-test for each A_{W} and to set the unreliable A_{W} to zero, so as to improve the reliability of expression (11).

According to the above-described computing procedure, the temperature Tₙₐ (∞) of component n can be computed using the emission spectrum Iₐ (λₚ) of cleaning S3 at an arbitrary a-th cleaning after the x-th cleaning.

However, since the computing procedure from expression (9) to expression (10) is complex, it is also possible to utilize the following method. Expression (12) is obtained by substituting expression (9) in expression (10).

[Expression 10 ]

Tₙₐ=Aₒ+ΣₚΣ_{y}(Iₐ(λₚ)−I_{A}(λₚ))A_{W}L_{W}(λₚ) (12)

By defining and computing L_{Load} (λₚ) as shown in expression (13), the prediction expression (12) can be simplified as expression (14).

[Expression 11 ]

T_{Load}(λₚ)=Σ_{W}A_{W}L_{W}(λₚ) (13)

Tₙₐ=A_{O}+Σₚ(Iₐ(λₚ)−I_{A}(λₚ))L_{Load}(λₚ) (14)

It is recognized that by adopting the format of expression (8), the temperature Tₙₐ in the plasma processing chamber at that time can be computed based on emission spectrum Iₐ (λₚ).

Further, in order to create prediction expressions (11) or (14) via the above-mentioned principal component analysis, x can be an arbitrary integer of 3 or greater, but according to the experiences of the present inventors, x should preferably be equal to or greater than 5 and equal to or smaller than 10. Further, as an example, the S_{pq} has been set as a matrix element of variance-covariance matrix, but the S_{pq} can also be a correlation matrix element. The correlation matrix element can be computed using a generally-known computation method. When a correlation matrix is adopted, the computation methods from expression (9) to expression (14) are somewhat varied, but it is possible to adopt well-known methods, such as those disclosed in textbooks on principal component analysis to perform the actual computation. Refer for example to Principal Component Analysis (Springer Series in Statistics I. T. Jolliffe).

Further, by observing expression (14), it can be seen that L_{Load} (λ_{P}) is a proportionality coefficient at wavelength λ_{P}. It is possible to select more than one (approximately a several) appropriate wavelengths in which |L_{Load} (λ_{P}) is great, so as to create a prediction expression of Tₙₐ via a multiple regression equation using those values as explaining variables.

Next, we will move on to the procedure of FIG. 7B. A single lot is processed via a normal method as described with reference to FIG. 2 (S1 through S4 ). When the process is completed, the plasma processing chamber temperature Tₙ at that time is computed via the emission spectrum obtained during the last cleaning S3 in step S9, and the computed value is defined as T_{nL}. Through procedures of FIG. 7A and FIG. 7B, the temperature T_{nL} to be achieved by the lot pretreatment S1 can be obtained, and thus, it is possible to determine the plasma generating condition of the lot pretreatment S1 to obtain the target T_{nL}.

The above-described analysis method illustrates one example of a method for correlating the relationship between the component temperature Tₙₐ within the plasma processing chamber and the emission spectrum, and any other known method can be used. The thus-created model expression is stored in the model storage unit 26, and is read out from the model storage unit 26 when necessary to compute the temperature of the plasma processing chamber.

The above describes the method for computing the temperature of the plasma processing chamber using the emission spectrum of plasma, but here, the emission spectrum of plasma to be correlated with the temperature of the plasma processing chamber can be other than the emission during cleaning S3, and in another possible example, the emission spectrum of plasma within ten or more seconds after starting the plasma process S2 can be correlated with the temperature of the plasma processing chamber. Further, not only the emission spectrum of plasma, but apparatus data such as the valve 3, the pressure gauge 5, the temperature measured via the temperature measuring means 15, the plasma generating tuner 9 and the bias tuner 13 can be correlated with the plasma processing temperature chamber instead of the emission spectrum to perform the present invention. The above-mentioned apparatus data can also be simultaneously used with the emission spectrum.

As described, according to the present invention, temperature can be measured without attaching a temperature measuring device within the plasma processing chamber, and the heating condition of the processing chamber through plasma can be optimized.

### Embodiment 3

The second embodiment described a method for setting the target temperature so as to discover the temperature to be achieved via the lot pretreatment S1 in order to enhance the reproducibility of the plasma processing S2. However, the level of accuracy for achieving the target temperature required to realize the effect is not clear according to embodiment 2. Therefore, the method for computing the required accuracy level will be described hereafter as embodiment 3.

In embodiment 3, an acceptable temperature fluctuation is computed by correlating the relationship between the result of plasma processing S2 in FIG. 2 and the temperature observed during the cleaning S3 immediately prior to the plasma processing.

As an example, it is assumed that the transistor gate dimension formed on the semiconductor wafer via the plasma processing S2 is measured. It is assumed that the gate dimension at the y-th processing is G_{y}, and during the cleaning S3 performed immediately prior to the y-th processing, the temperature set of the plasma processing chamber is {T_{ny}}. It is assumed that x gate dimensions G_{y} and temperature sets {T_{ny}} are obtained. These temperature sets {T_{ny}} and gate dimensions G_{y} are stored via the data input means 24 to the database 25.

Then, the operation unit 24 correlates these two data for example via a correlating equation (15).

[Expression 12 ]

G=G_{O}=Σₖ(∂Gₖ/∂Tₖ)Tₖ (15)

An intercept Gₒ or the coefficient (∂Gₖ/∂Tₖ) can be determined via a common multiple regression analysis, but since the temperatures of components are generally mutually correlated, it is more preferable to determine the same via a principal component regression analysis. A well-known common method can be used for performing such regression analysis. When expression (15) is created, the operation unit 24 stores the expression in the model storage unit 26.

The relationship between the gate dimension which is the result of the plasma processing S2 and the temperature of the plasma processing chamber is obtained via expression (15), so the obtained relationship can be used to compute the acceptable temperature fluctuation enabling to realize the target gate dimension accuracy. The acceptable temperature range can be determined based on a well-known error propagation rule and the performance of the plasma processing apparatus. The boundary conditions of these temperatures are further stored in the database 25, and the operation unit 24 combines the same with the expression (15) stored in the model storage unit 26 to determine an optimum condition of lot pretreatment S1. The determined condition of lot pretreatment S1 is displayed on the display unit 22, so as to notify the same to the user of the apparatus. The determined condition can either be performed automatically as the lot pretreatment condition by the operation unit 24, or be set manually by the user of the apparatus.

Further, the above-mentioned example is described using as an example the gate dimension of the transistor on the semiconductor wafer, but other results of plasma processing that can generally be evaluated quantitatively can also be correlated with the plasma processing chamber temperature through a similar method.

According to the above-mentioned third embodiment of the present invention, it becomes possible to clearly determine the acceptable level of temperature fluctuation in order to maintain the processing accuracy of the plasma processing S2 to a target value, and thus, it becomes possible to determine the appropriate plasma generating condition for the lot pretreatment S1 based thereon.

What is claimed is:

1. A plasma processing method using a plasma processing apparatus comprising a database for correlating and storing an inner temperature of a plasma processing chamber and a plasma generating condition, a model expression storage unit for storing a correlating equation of the inner temperature of the plasma processing chamber and the plasma generating condition from the database, and a computing machine including an operation unit for creating the correlating equation and computing the optimum plasma generating condition, the method comprising:
computing via the computing machine a plasma generating condition determined so that the temperature of the plasma processing chamber reaches a desired temperature by performing rapid heating within the plasma processing chamber and thereafter performing highly accurate control of the temperature within the plasma processing chamber.

2. The plasma processing method according to claim 1, wherein
two or more plasma processing conditions are used for controlling the temperature of the plasma processing chamber, wherein one of the conditions is for generating plasma capable of applying a high thermal energy to the plasma processing chamber, and the other condition is a plasma generating condition adjusted to highly accurately control the temperature of the plasma processing chamber to a desired temperature.

3. The plasma processing method according to claim 1, wherein
the plasma processing apparatus comprises a database for correlating and storing a plasma processing result and the temperature of the plasma processing chamber; and
a model expression storage unit for storing the correlating equation capable of computing the plasma processing result from the plasma processing chamber temperature based on the database; wherein
the computing machine having an operation unit for computing the acceptable temperature range based on the correlating equation and the correlating equation is used to compute the plasma generating condition capable of setting the temperature of the plasma processing chamber within said temperature range from a desired temperature.

4. A plasma processing apparatus for subjecting an object to be processed within a plasma processing chamber to plasma processing comprising:
a database for correlating and storing an inner temperature of a plasma processing chamber and a plasma generating condition;
a model expression storage unit for storing a correlating equation of the inner temperature of the plasma processing chamber and the plasma generating condition computed using the database; and
a computing machine including an operation unit for creating the correlating equation and computing the optimum plasma generating condition.

5. The plasma processing apparatus according to claim 4, comprising:
a process monitor for monitoring the condition of plasma processing; and
a database for correlating and storing the value output by the process monitor and the temperature of the plasma processing chamber; wherein
the computing machine includes a model equation storage unit storing the correlating equation for computing based on the database the temperature of the plasma processing chamber from the value output from the process monitor; and
an operation unit capable of computing the correlating equation and the temperature of the plasma processing chamber based on the correlating equation; wherein
a plasma processing condition capable of realizing a substantially constant plasma processing chamber temperature is computed, and the plasma processing is performed based on the computed condition.
